(19) United States
(12) Patent Application Publication
(10) Pub. No.: US 2012/0089584 A1
(43) Pub. Date: Apr. 12, 2012

(54) METHOD AND MOBILE TERMINAL FOR PERFORMING PERSONALIZED SEARCH

(75) Inventors: Yeo Chan YOON, Seoul (KR); Soojong LIM, Daejeon (KR); Hyo-Jung OH, Daejeon (KR); HyunKi KIM, Daejeon (KR); Pum Mo RYU, Daejeon (KR); Chung Hee LEE, Daejeon (KR); Jeong HEO, Daejeon (KR); Changki LEE, Daejeon (KR); Miran CHOI, Daejeon (KR); Yoonjae CHOI, Gangwon-do (KR); Ji Ae SHIN, Daejeon (KR); Myung Gil JANG, Daejeon (KR); Sang Kyu PARK, Daejeon (KR)

(73) Assignee: Electronics and Telecommunications Research Institute, Daejeon (KR)

(21) Appl. No.: 13/191,021

(22) Filed: Jul. 26, 2011

(30) Foreign Application Priority Data
Oct. 12, 2010 (KR) 10-2010-0099546

(51) Int. Cl. G06F 17/30

(52) U.S. Cl. 707/706; 707/769; 707/E17.108; 707/E17.014

(57) ABSTRACT

Provided are a method and mobile terminal for performing a personalized search, capable of providing search results optimized for a user in consideration of location and user preference. The method includes acquiring a question keyword from a user and information about the location of a mobile terminal, making a local search on the basis of the question keyword and the location information to generate local search results, displaying the local search results and storing a use record of the user of the mobile terminal corresponding to the displayed local search results, generating a user preference analysis model using the location information and the use record, then applying the generated user preference analysis model to the local search results, and deducing personalized final local search results from the local search results. Thus, it is possible to provide the local search results optimized for the user.

### CLAIM FOR PRIORITY

This application claims priority to Korean Patent Application No. 10-2010-0099546 filed on Oct. 12, 2010 in the Korean Intellectual Property Office (KIPO), the entire contents of which are hereby incorporated by reference.

### BACKGROUND

1. Technical Field

Example embodiments of the present invention relate in general to search technology using mobile terminals and, more specifically, to a method and mobile terminal for performing a personalized search, capable of reflecting a preference of a user to provide optimized search results to the user.

2. Related Art

In recent years, the evolution of mobile telecommunications technology and the development of processor technology have led to mobile terminals having a data communication function allowing high-speed Internet use in a mobile communication network or short-range wireless communication network environment, in addition to voice and video telephony functions.

Further, mobile terminals having a location recognition function recognize current locations of users carrying them in real time, and provide a local search service based on the recognized locations, in order to further improve user convenience.

Such a local search service involves searching for establishments such as pharmacies, hospitals and restaurants in the current vicinity of the user, and providing the search results. Alternatively, it may involve searching for types of establishments specified by the user, or for establishments located within a district specified by the user. The local search service, by nature, is mainly provided through mobile terminals such as mobile phones, smart phones, personal digital assistants (PDAs), etc., which are portable and can provide a greater variety of functions when combined with position tracking technology such as a global positioning system.

Meanwhile, since the local search service is mainly provided through the mobile terminal, it can provide convenience based on the portability of the mobile terminal. However, due to the limit of a display screen size of the mobile terminal, it is difficult to freely display the search results.

For example, since the display screen size of the mobile terminal is generally within four inches, the number of search results that it can display is limited to several results. Thus, when there are several tens to several hundreds of search results, and when information sought by the user is located somewhere down a list of the search results, the user has no alternative but to operate the mobile terminal, for instance, by continuously scrolling the display screen of the mobile terminal, to find his/her desired search results. This is rather inconvenient.

Thus, to improve convenience of the local search service provided through the mobile terminal, it is important to select and display only pertinent search results. To this end, a process enabling the mobile terminal to identify the intent of the user and provide search results that are optimized with respect to the search intent of the user is required.

Meanwhile, personalized search methods have been studied for several years in order to identify the search intent of the user and thereby improve search performance. One of them involves analyzing Internet use patterns in order to determine the intent of the user, and preferentially displaying data corresponding to search results which have been previously clicked.

Such personalized search methods refer only to the user's search history to provide search results. As such, when information that has been searched for once is searched for again, search results can be efficiently provided. However, it is impossible to actively provide search results that optimized with respect to user preference and current location.

Further, among the personalized search methods, another method is adapted to analyze search histories of a plurality of users in advance in order to identify a field of interest to the user, reflect it in search results, establish a search data classification system, and provide search results using the search data classification system when the user makes a search. Since this method also provides the search results depending on statistical data acquired from the plurality of users, it is incapable of providing search results that are customized based on the individual user's preferences.

### SUMMARY

Accordingly, example embodiments of the present invention are provided to substantially obviate one or more problems due to limitations and disadvantages of the related art.

Example embodiments of the present invention provide a method of performing a personalized search, capable of providing optimized search results to the user of a mobile terminal in consideration of a current location and user preference.

Example embodiments of the present invention also provide a mobile terminal for performing a personalized search, capable of providing optimized search results to a user of the mobile terminal in consideration of a current location and user preference.

The technical problems overcome by the proposed embodiments are not limited to the foregoing. Other technical achievements and advantages of the proposed embodiments, which may not be described explicitly herein, will nevertheless be clearly understood by those skilled in the art from the following description.

In some example embodiments, a method of performing a personalized search includes: acquiring a question keyword from a user and information about the location of a mobile terminal; making a local search on the basis of the question keyword and the location information to generate local search results; displaying the local search results and storing a use record of the user of the mobile terminal corresponding to the displayed local search results; and generating a user preference analysis model using the location information and the use record.

The use record may include at least one of a record of item selection from the local search results, a call record associated with the local search results, a record of text messages exchanged using a messenger or twitter service, and an e-mail exchange record.

The process of generating a user preference analysis model may include identifying a favorite district of the user on the basis of the location information and the use record to generate a user favorite district analysis model.

The process of generating a user preference analysis model may include determining a favorite establishment type of the user on the basis of the use record to generate a user favorite establishment type analysis model.

The process of generating a user preference analysis model may include acquiring establishment type classification information that classifies information about an establishment type to which each establishment site belongs, prior to generating the favorite establishment type analysis model of the user.

The process of generating a user preference analysis model may include determining a favorite brand of the user on the basis of the use record to generate a user favorite brand analysis model.

The process of generating a user preference analysis model may include acquiring brand classification information that classifies information about a brand to which each establishment site belongs, prior to generating the user favorite brand analysis model.

The process of generating a user preference analysis model may include determining a favorite establishment site of the user on the basis of the use record to generate a user favorite establishment site analysis model.

The method may further include applying the generated user preference analysis model to the local search results, and deducing personalized final local search results from the local search results.

In other example embodiments, a method of performing a personalized search includes: acquiring a question keyword from a user and information about the location of a mobile terminal; making a local search on the basis of the question keyword and the location information to generate primary local search results; and applying a previously generated user preference analysis model to the primary local search results, and deducing personalized final local search results corresponding to user preference from the local search results.

In still other example embodiments, a mobile terminal for performing a personalized search includes: an input/output part that displays a user interface for receiving a question keyword which a user inputs; a location determiner that determines a current location of the mobile terminal and provides information about the determined location; a wireless communication part that provides the question keyword input by the user and the location information to a local search engine, and receives local search results from the local search engine; a search controller that controls the input/output part to display the local search results, and stores and provides a use record associated with the local search results; a storage part that stores the use record in response to control of the search controller; a user preference analysis model generator that generates a user preference analysis model using the use record and the location information; and a personalized search engine that applies the user preference analysis model to the local search results and deduces personalized final search results.

The user preference analysis model generator may analyze at least one of a favorite district, a favorite establishment type, a favorite brand, and a favorite establishment site of the user on the basis of at least one of the location information and the use record to generate the preference analysis model.

The personalized search engine may preferentially extract search results, which are included in a district, an establishment type, a brand, or an establishment site which the user prefers, from the local search results using the user preference analysis model.

The personalized search engine may extract search results, which are included in a district, an establishment type, a brand, or an establishment site which the user prefers, from the primary local search results using the user preference analysis model, and may extract the personalized final local search results from the extracted search results in consideration of age or a gender of the user.

### BRIEF DESCRIPTION OF DRAWINGS

Example embodiments of the present invention will become more apparent by describing in detail example embodiments of the present invention with reference to the accompanying drawings, in which:

FIG. 1 is a flowchart showing a process of generating a user preference analysis model used for a method of performing a personalized search according to an example embodiment of the present invention;

FIG. 2 is a flowchart showing a method of performing a personalized search according to an example embodiment of the present invention;

FIG. 3 shows a user interface screen for explaining a method of performing a personalized search according to an example embodiment of the present invention; and

FIG. 4 is a block diagram showing configuration of a mobile terminal using a method of providing a personalized search according to an example embodiment of the present invention.

### DESCRIPTION OF EXAMPLE EMBODIMENTS

The invention may be subject to various modifications and alternative forms. Accordingly, specific embodiments thereof are shown by way of example in the drawings and will herein be described in detail.

It should be understood, however, that there is no intent to limit the invention to the particular forms disclosed. On the contrary, the invention is to cover all modifications, equivalents, and alternatives falling within the spirit and scope of the claims. Like reference numerals refer to like elements throughout the description of the figures.

The terminology used herein is for the purpose of describing particular embodiments only and is not intended to limit the scope of the invention. Elements referred to as singular using “a,” “an” and “the,” may also be pluralities unless the context clearly indicates otherwise. It will be further understood that the terms “comprises,” “comprising,” “includes” and/or “including,” when used herein, specify the presence of stated features, numbers, steps, operations, elements, and/or components, but do not preclude the presence or addition of one or more other features, numbers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in greater detail with reference to the accompanying drawings. In the following detailed description, the same reference numeral will be used for the same component or components regardless of the figures in order to facilitate understanding of example embodiments of the invention.

In the following embodiments of the invention, the term “mobile terminal” may refer to a mobile station (MS), user equipment (UE), a user terminal (UT), a wireless terminal, a wireless device, a wireless communication device, a wireless transmit/receive unit (WTRU), a portable mobile phone, or other equivalent device. Various examples of the mobile terminal are: cellular phones, smart phones having a wireless communication function, personal data assistants (PDAs) having a wireless communication function, wireless modems, portable computers having a wireless communication function, photographing devices such as digital cameras having a wireless communication function, gaming devices having a wireless communication function, music storing and reproducing household electric appliances having a wireless communication function, Internet household electric appliances allowing wireless Internet accessing and browsing, and portable units or terminals integrating combinations of these functions. However, the mobile terminal may be embodied in other forms.

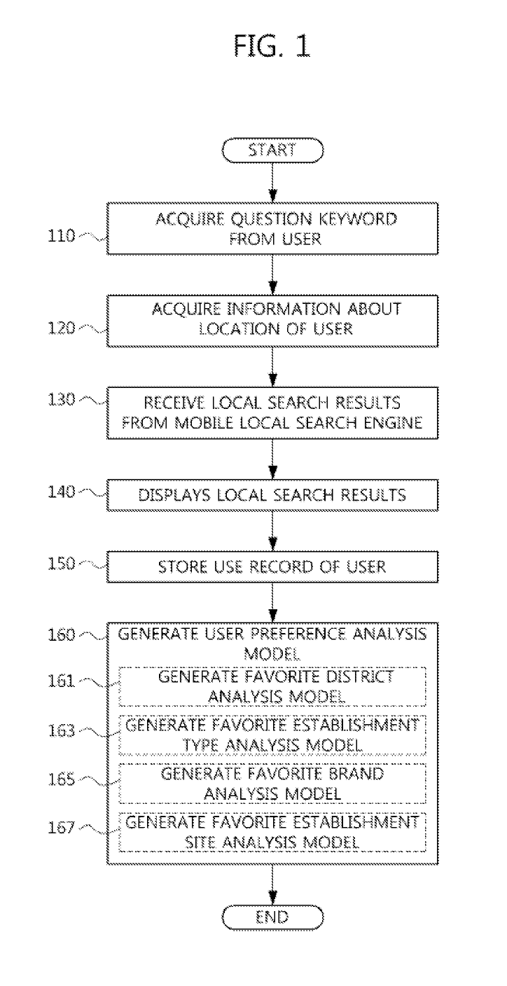

FIG. 1 is a flowchart showing a process of generating a user preference analysis model used for a method of performing a personalized search according to an example embodiment of the present invention.

Referring to FIG. 1, when a personalized search is performed, a mobile terminal provides a user with a user interface for providing the personalized search, and acquires a question keyword which the user inputs through the user interface (step 110). Here, the mobile terminal displays the user interface through a display part thereof such that the user inputs the question keyword by the same method as using a conventional Web search service.

Further, the mobile terminal acquires information about a current location of the user (step 120). Here, the current location information of the user refers to information on a current location of the mobile terminal which the user carries with him/her. Hereinafter, it is assumed that the mobile terminal provides a local search service while being carried by the user. The location information of the user and the location information of the mobile terminal are used in the same sense.

The location information of the user may be used to analyze a favorite district of the user. The mobile terminal can identify the favorite district of the user in terms of detailed administrative districts (e.g. Korea (country), si or do (city), gu (ward), dong (town)) using the location information corresponding to the question keyword which the user inputs.

In FIG. 1, an example of performing step 120 after step 110 is shown. This is merely for convenience of description. Thus, step 110 and step 120 may be performed simultaneously, or step 120 may be followed by step 110.

Next, the mobile terminal provides a mobile local search engine with the question keyword which the user inputs, and receives local search results, which correspond to the question keyword which the user inputs, from the mobile local search engine (step 130). Here, the mobile terminal may provide the mobile local search engine with the question keyword which the user inputs and the current location information of the user. The mobile local search engine makes a search in multilateral consideration of correspondence between the question keyword and the name of an establishment site as a search target, a distance between the current location of the user and the search target, and so on, and then may provide the local search results to the mobile terminal.

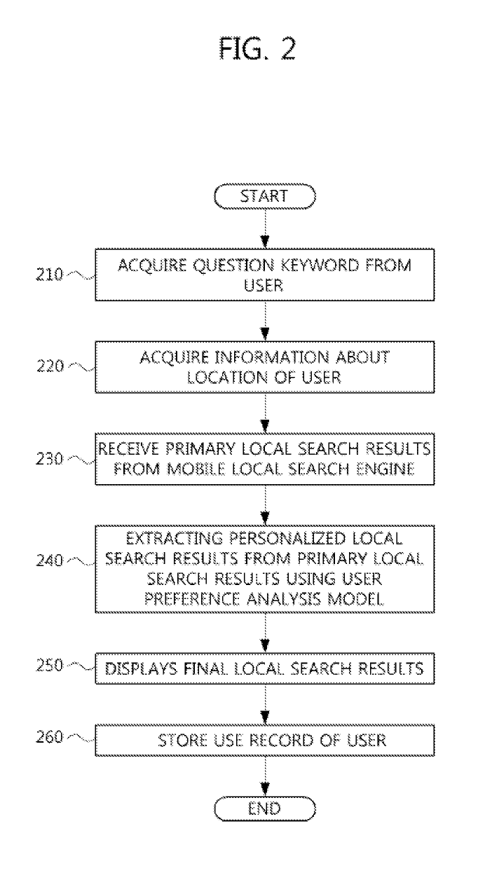

Further, the local search results provided in step 130 may be primary local search results that are obtained on the basis of the current location of the user and the question keyword of the user, or final search results that are obtained on the basis of a personalized search (see FIG. 2) which will be described below.

The mobile terminal displays the local search results, which are provided from the mobile local search engine, on the display part (step 140), and, when the user selects a desired item from among the displayed local search results or attempts to call a desired establishment site, stores this use record of the user (step 150). Here, the use record of the user may include a record of text messages exchanged in association with the search results, a record of text messages exchanged using a messenger or twitter service, an e-mail exchange record, etc. in addition to the search result selection and the phone call of the user.

The use record of the user is used as data for analyzing user preferences, and may be used to provide final search results of the personalized search in future.

Afterwards, the mobile terminal generates a preference analysis model using the location information and the use record of the user (step 160). In detail, the process of generating the user preference analysis model may generally include generating a favorite district analysis model, generating a favorite establishment type analysis model, generating a favorite brand analysis model, and generating a favorite establishment site analysis model.

The process of generating a favorite district analysis model (step 161) includes identifying a favorite district of the user using the location information and use record of the user to generate the favorite district analysis model. For example, the mobile terminal identifies which district the user frequently goes to using the location information of the user, and determines which district the user prefers on the basis of the use record such as the frequency of search item selection and the frequency of phone calling, thereby identifying the favorite district of the user. The mobile terminal arranges and stores the favorite district of the user identified as described above according to the preference, thereby generating the favorite district analysis model.

The process of generating a favorite establishment type analysis model (step 163) involves determining a favorite establishment type of the user using the use record of the user. To this end, the mobile terminal retains establishment type classification information about to which establishment type the corresponding establishment site belongs. For example, the mobile terminal must retain information that the establishment site “Starbucks Cheonho branch” belongs to the establishment type “coffee special store.” To this end, the mobile terminal classifies the establishment type of each establishment site, and establishes and uses information about to which establishment type the establishment site to be searched belongs. Alternatively, the mobile terminal may receive information about the establishment type corresponding to each establishment site from an external database server that retains the establishment type of each establishment site, thereby establishing the establishment type classification information. The mobile terminal arranges and stores the favorite establishment type of the user which is identified as described above according to the preference, thereby generating the favorite establishment type analysis model.

The process of generating a favorite brand analysis model (step 165) involves analyzing a favorite brand of the user using the use record of the user. To this end, the mobile terminal retains information about to which brand the corresponding establishment site belongs. For example, the mobile terminal must retain brand classification information that the establishment site “Starbucks Cheonho branch” belongs to the brand “Starbucks.” To this end, the mobile terminal establishes and uses information about in which brand the establishment site to be searched for is included. Alternatively, the mobile terminal may acquire and use the brand classification information about each establishment site from an external database server. The mobile terminal arranges and stores the favorite brand of the user which is identified as described above according to the preference, thereby generating the favorite brand analysis model.

The process of generating a favorite establishment site analysis model (step 167) involves analyzing a favorite establishment site of the user using the use record of the user.

Here, the favorite establishment site refers to a regular establishment site which the user prefers to other establishment sites. The mobile terminal may determine the favorite establishment site in consideration of the use record of the user according to the establishment type, and generate the favorite establishment site analysis model. For example, in the case of the establishment type “coffee special store,” the favorite establishment site may be “Starbucks Cheonho branch.” In the case of the establishment type “general hospital,” the favorite establishment site may be “Asan hospital.” The mobile terminal arranges and stores the favorite establishment site of the user which is identified as described above according to the preference, thereby generating the favorite-site analysis model.

Steps 161 through 167 may be performed regardless of their order, and the generated user preference analysis model may be updated depending on a change in location caused by movement of the user or a change in the use record of the user.

Further, the user preference analysis model is used to be applied to local search results searched by the local search engine as shown in FIG. 2 below and to deduce favorite search results of the user from the local search results.

FIG. 2 is a flowchart showing a method of performing a personalized search according to an example embodiment of the present invention.

Referring to FIG. 2, when a personalized search is performed, a mobile terminal provides a user with a user interface for providing the personalized search, and acquires a question keyword which the user inputs through the user interface (step 210). Here, the mobile terminal displays the user interface through a display part thereof such that the user inputs the question keyword by the same method as when using a conventional Web search service.

Further, the mobile terminal acquires information about a current location of the user (step 220). Here, the location information of the user may be used to analyze a favorite district of the user. The mobile terminal can identify the favorite district of the user in terms of detailed administrative districts (e.g. Korea (country), si or do (city), gu (ward), dong (town)) using the location information corresponding to the question keyword which the user inputs.

In FIG. 2, step 220 is performed after step 210, but this is merely an example. Alternatively, step 210 and step 220 may be performed simultaneously, or step 220 may be followed by step 210.

Next, the mobile terminal provides a mobile local search engine with the question keyword which the user inputs, and receives primary local search results, which correspond to the question keyword which the user inputs, from the mobile local search engine (step 230). Here, the mobile terminal may provide the mobile local search engine with the question keyword which the user inputs and the current location information of the user. The mobile local search engine makes a search in multilateral consideration of correspondence between the question keyword and the name of an establishment site as a search target, a distance between the current location of the user and the search target, and so on, and then may provide the primary local search results to the mobile terminal.

Afterwards, the mobile terminal processes the primary local search results, which are provided from the mobile local search engine, using the user preference analysis model generated as shown in FIG. 1, thereby extracting personalized local search results (step 240). Here, the mobile terminal extracts the personalized local search results from the primary local search results using a favorite district analysis model, a favorite establishment type analysis model, a favorite brand analysis model, and a favorite establishment site analysis model.

In detail, when a name of the same district as the question keyword input by the user is present within the primary local search results, the mobile terminal preferentially searches for a favorite district of the user using the generated favorite district analysis model. For example, when the user inputs a “Seo-gu restaurant” as the question keyword and thus restaurants located at the districts of “Daejeon Seo-gu” and “Ulsan Seo-gu” are provided as primary local search results, the mobile terminal determines which one of the two districts is the favorite district of the user using the favorite district analysis model. If the “Daejeon Seo-gu” district is determined to be the favorite district of the user, the mobile terminal ranks information about the restaurants located at the “Daejeon Seo-gu” district above information about the restaurants located at the “Ulsan Seo-gu” district in terms of a search result rank. Here, the search result rank refers to an order in which the search results are displayed or arranged. It means that the higher the search result rank, the earlier the search results can be displayed on the display screen of the mobile terminal.

Further, when the user inputs a name of a major administrative district as the question keyword, the mobile terminal preferentially searches smaller administrative districts included within the major administrative district for ones which the user prefers. For example, when the user inputs a question keyword “Daejeon restaurant” and thus the restaurants located at districts of “Daejeon Eunhaeng-dong” and “Daejeon Dunsan-dong” are provided as the primary local search results, the mobile terminal determines which one of the two districts is the favorite district of the user using the favorite district analysis model. If it is determined that the user usually prefers the “Daejeon Dunsan-dong” district to the “Daejeon Eunhaeng-dong” district, the mobile terminal give a higher priority to information about the restaurants located at the “Daejeon Dunsan-dong” district, and thus ranks the information about the restaurants located at the “Daejeon Dunsan-dong” district above information about the restaurants located at the “Daejeon Eunhaeng-dong” district in terms of a search result rank.

The mobile terminal identifies a favorite establishment type of the user using the favorite establishment type analysis model, and determines whether or not the establishment site included in the establishment type which the user usually prefers is present within the primary local search results provided from the mobile local search engine. If the establishment site included in the establishment type which the user usually prefers is present, the mobile terminal ranks information about the corresponding establishment site high in the search results. For example, if the favorite establishment type of the user is “Spagetti,” and if the user inputs “matjib” as the question keyword (where “matjib” refers to a restaurant famous for delicious food), the mobile terminal causes the establishment site included in the establishment type “Spagetti” to have a higher search result rank than the establishment sites of the other establishment types within the primary local search results.

The mobile terminal identifies a favorite brand of the user using the favorite brand analysis model, and determines whether or not the establishment site included in the brand which the user usually prefers is present within the primary local search results provided from the mobile local search engine. If the establishment site included in the brand which the user usually prefers is present, the mobile terminal ranks information about the corresponding establishment site high in the search results. For example, if the favorite brand of the user is “Starbucks,” and if the user inputs “coffee” as the question keyword, the mobile terminal causes the establishment site having the brand “Starbucks” to have a higher search result rank than the establishment sites of the other brands within the primary local search results.

In addition, the mobile terminal identifies a favorite establishment site of the user using the favorite establishment site analysis model, and causes the favorite establishment site of the user to have a higher search result rank than the other establishment sites within the primary local search results provided from the mobile local search engine.

As described above, the mobile terminal can deduce the personalized local search results from the primary local search results using the favorite district analysis model, the favorite establishment type analysis model, the favorite brand analysis model, and the favorite establishment site analysis model. In addition, the mobile terminal may preferentially provide, as final search results, a district, establishment type, brand, and establishment site which the user prefers, and an establishment site which the user generally prefers according to age or gender in consideration of personal information such as age, gender, scholarship, job, etc. of the user.

In the process of providing the personalized final search results using the user preference analysis model in step 240, in addition to the aforementioned process of ranking search results according to user preference, a process of excluding search results which the user does not prefer from the primary local search results, using the preference analysis model, may be used, or the two processes may be used.

Further, the mobile terminal may give a priority to each of the favorite district analysis model, favorite establishment type analysis model, favorite brand analysis model, favorite establishment site analysis model, and personal information of the user, sequentially apply the analysis model according to the priority, and deduce the personalized final local search results from the primary local search results.

Afterwards, the mobile terminal displays the final local search results (step 250), and stores a use record of the user which is associated with the displayed final local search results (step 260). Here, the use record of the user is used as data for generating the user preference analysis model as shown in FIG. 1.

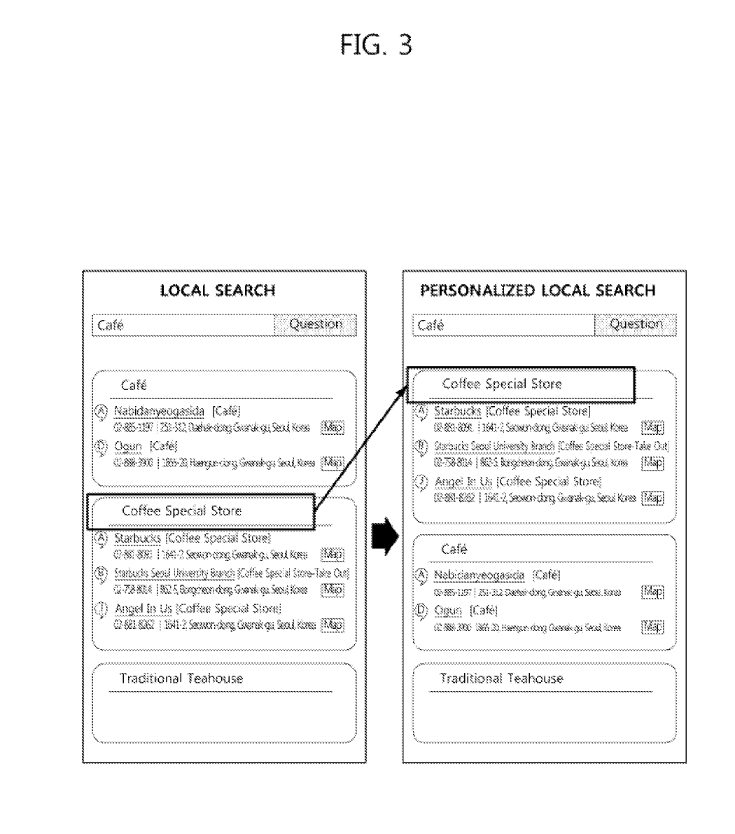

FIG. 3 shows a user interface screen for explaining a method of performing a personalized search according to an example embodiment of the present invention.

In the example shown in FIG. 3, when the user inputs a keyword “café” as a search question keyword, the mobile terminal applies the user preference analysis model to an establishment type such as “café,” “coffee special store,” “traditional teahouse,” etc., obtained as the primary local search results, and displays the most favorite establishment type “coffee special store” of the user so as to be ranked above the other establishment types. A brand “Starbucks” of the “coffee special store” is displayed as a most favorite brand of the user at a highest rank, and a “Starbucks” establishment site, which is located at a most favorite district of “Seowon-dong, Gwanak-gu, Seoul, Korea” among the establishment sites having the brand “Starbucks” is located at a highest rank.

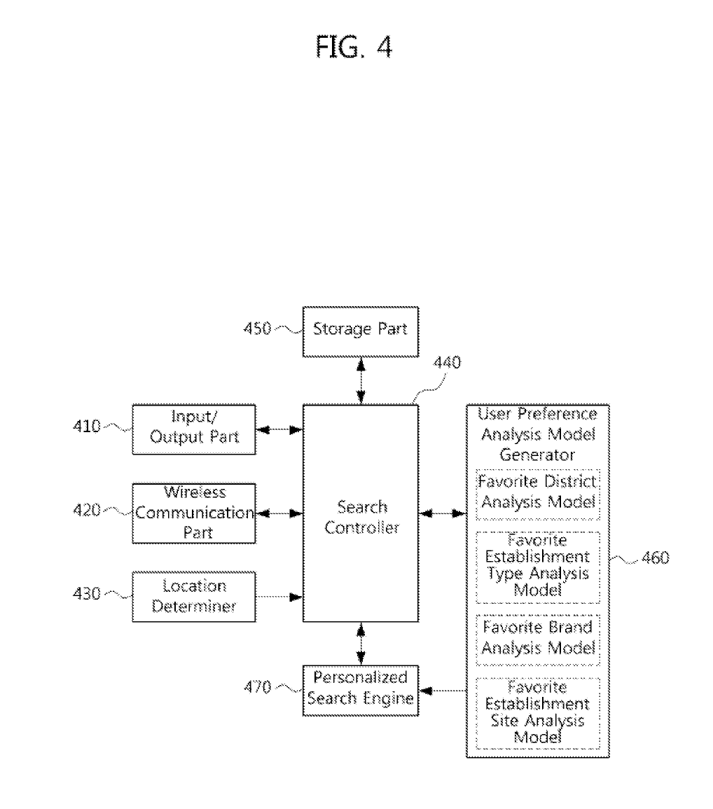

FIG. 4 is a block diagram showing configuration of a mobile terminal using a method of providing a personalized search according to an example embodiment of the present invention.

Referring to FIG. 4, the mobile terminal includes an input/output part 410, a wireless communication part 420, a location determiner 430, a search controller 440, a storage part 450, a user preference analysis model generator 460, and a personalized search engine 470.

The input/output part 410 may be made up of a touch screen, a keypad, or a display device. The input/output part 410 displays a user interface screen for receiving a question keyword from a user in response to control of the search controller 440, and primary local search results or personalized final local search results.

The wireless communication part 420 may be made up of a mobile communication modem, a portable Internet modem, or a wireless Internet modem for Code Division Multiple Access (CDMA), Wideband CDMA (WCDMA), Long Term Evolution (LTE), LTE-Advanced (LTE-A), High Speed Packet Access (HSPA), Wireless Broadband (WiBro), Worldwide Interoperability for Microwave Access (WiMAX), or Wi-Fi. The wireless communication part 420 provides a question keyword which the user inputs and information about a current location of the mobile terminal to an external local search engine via a wireless interface in response to control of the search controller 440, and provides primary local search results received from the external local search engine to the search controller 440.

The location determiner 430 may be made up of a global positioning system (GPS) device, and provides the current location information of the mobile terminal to the search controller 440. Alternatively, the location determiner 430 may be configured to determine a location of the mobile terminal using a variety of known methods such as specific information sent from a base station of a mobile communication network, intensity of a received signal sent from each base station, and so on, and to provide information about the determined location to the search controller 440, without a separate device for location recognition.

The search controller 440 controls the input/output part 410 to display the user interface screen for receiving the question keyword from the user when the personalized local search service is provided, and receives the question keyword which the user inputs from the input/output part 410. Further, the search controller 440 receives the current location information of the mobile terminal from the location determiner 430, and sends the question keyword and the location information to the external local search engine through the wireless communication part 420.

Afterwards, the search controller 440 controls the input/output part 410 to display the search results, i.e. the primary local search results, provided from the local search engine. Then, when the user selects a desired item from among the displayed local search results or attempts to call a desired establishment site, the search controller 440 stores this use record of the user, and simultaneously provides it to the user preference analysis model generator 460. Here, the use record of the user may include a record of text messages exchanged in association with the search results, a record of text messages exchanged using a messenger or twitter service, an e-mail exchange record, etc. in addition to the search result selection and the phone call of the user.

Further, the search controller 440 provides the primary local search results to the personalized search engine 470, and controls the input/output part 410 to display the personalized final local search results provided from the personalized search engine 470.

The storage part 450 stores the use record of the user under the control of the search controller 440. Further, the storage part 450 may store a user preference analysis model generated from the user preference analysis model generator 460.

The user preference analysis model generator 460 generates a user preference analysis model on the basis of the use record of the user and the current location information of the mobile terminal, both of which are provided from the search controller 440.

In detail, the user preference analysis model generator 460 can generate a favorite district analysis model, a favorite establishment type analysis model, a favorite brand analysis model, and a favorite establishment site analysis model.

The user preference analysis model generator 460 identifies the favorite district of the user using the location information and use record of the user, and generates the favorite district analysis model. For example, the user preference analysis model generator 460 identifies which district the user frequently goes to on the basis of the location information of the user, and determines within which district the user prefers an establishment site on the basis of the use record such as the frequency of search item selection and the frequency of phone calling, thereby finally identifying the favorite district of the user.

Further, the user preference analysis model generator 460 determines a favorite establishment type of the user using the use record of the user, and generates a user favorite establishment type analysis model. To this end, the user preference analysis model generator 460 classifies the establishment type of each establishment site, and establishes and uses information about which establishment type includes the establishment site to be searched for. Alternatively, the user preference analysis model generator 460 may receive information about the establishment type corresponding to each establishment site from an external database server that retains names of the establishment types of the establishment sites, thereby creating establishment type classification information.

The user preference analysis model generator 460 analyzes a favorite brand of the user using the use record of the user, thereby generating a user favorite brand analysis model.

To this end, the user preference analysis model generator 460 establishes and uses information about which brand corresponds to the establishment site to be searched for. Alternatively, the user preference analysis model generator 460 may acquire and use brand classification information about each establishment site from an external database server. The user preference analysis model generator 460 analyzes a favorite establishment site of the user using the use record of the user, thereby generating a user favorite establishment site analysis model.

The user preference analysis model generator 460 updates the favorite district analysis model, favorite establishment type analysis model, favorite brand analysis model, and favorite establishment site analysis model of the user which are generated as described above whenever the location of the mobile terminal and the use record of the user are altered.

The personalized search engine 470 receives the primary local search results from the search controller 440, applies the user preference analysis model received from the user preference analysis model generator 460 to the primary local search results, and deduces personalized final local search results corresponding to the preference of the user. Here, the personalized search engine 470 may deduce the personalized final local search results using a method of assigning a high rank to search results having a high user preference, a method of excluding search results which the user does not prefer from the primary local search results using the preference analysis model, or the two methods.

The personalized final local search results deduced as described above may be provided to the search controller 440, and the search controller 440 may control the input/output part 410 to display the search results.

According to the method and mobile terminal for performing a personalized search as described above, it is possible to generate the user preference analysis model which includes district, establishment type, brand, and establishment site on the basis of the location information and the use record of the user of the search results, to apply the user preference analysis model to the local search results obtained by the local search engine, and to preferentially provide the personalized local search results optimized with respect to user preference.

Accordingly, it is possible to efficiently display the local search results on the mobile terminal having a small screen, and thus improve the convenience of use.

While example embodiments of the present invention and their advantages have been described in detail, it should be understood that various changes, substitutions and alterations may be made herein without departing from the scope of the invention.

What is claimed is:

1. A method of performing a personalized search, comprising:
acquiring a question keyword from a user and information about a location of a mobile terminal;
making a local search on the basis of the question keyword and the location information to generate local search results;
displaying the local search results and storing a use record of the user of the mobile terminal corresponding to the displayed local search results; and
generating a user preference analysis model using the location information and the use record.

2. The method of claim 1, wherein the use record includes at least one of a record of item selection from the local search results, a call record associated with the local search results, a record of text messages exchanged using a messenger or twitter service, and an e-mail exchange record.

3. The method of claim 1, wherein the generating of a user preference analysis model includes identifying a favorite district of the user on the basis of the location information and the use record to generate a user favorite district analysis model.

4. The method of claim 1, wherein the generating of a user preference analysis model includes determining a favorite establishment type of the user on the basis of the use record to generate a user favorite establishment type analysis model.

5. The method of claim 4, wherein the generating of a user preference analysis model includes acquiring establishment type classification information that classifies information about an establishment type to which each establishment site belongs, prior to generating the favorite establishment type analysis model of the user.

6. The method of claim 1, wherein the generating of a user preference analysis model includes determining a favorite brand of the user on the basis of the use record to generate a user favorite brand analysis model.

7. The method of claim 6, wherein the generating of a user preference analysis model includes acquiring brand classification information that classifies information about a brand to which each establishment site belongs, prior to generating the user favorite brand analysis model.

8. The method of claim 1, wherein the generating of a user preference analysis model includes determining a favorite establishment site of the user on the basis of the use record to generate a user favorite establishment site analysis model.

9. The method of claim 1, further comprising: applying the generated user preference analysis model to the local search results, and deducing personalized final local search results from the local search results.

10. A method of performing a personalized search, comprising:
acquiring a question keyword from a user and information about a location of a mobile terminal;
making a local search on the basis of the question keyword and the location information to generate primary local search results; and
applying a previously generated user preference analysis model to the primary local search results, and deducing personalized final local search results corresponding to user preference from the local search results.

11. The method of claim 10, wherein the deducing of personalized final local search results includes preferentially extracting search results, which are included in a district, an establishment type, a brand, or an establishment site which the user prefers, from the primary local search results using the user preference analysis model.

12. The method of claim 11, wherein the deducing of personalized final local search results includes extracting search results, which are included in a district, an establishment type, a brand, or an establishment site which the user prefers, from the primary local search results using the user preference analysis model, and extracting the personalized final local search results from the extracted search results in consideration of age or a gender of the user.

13. A mobile terminal comprising:
an input/output part that displays a user interface for receiving a question keyword which a user inputs;
a location determiner that determines a current location of the mobile terminal and provides information about the determined location;
a wireless communication part that provides the question keyword input by the user and the location information to a local search engine, and receives local search results from the local search engine;
a search controller that controls the input/output part to display the local search results, and stores and provides a use record associated with the local search results;
a storage part that stores the use record in response to control of the search controller;
a user preference analysis model generator that generates a user preference analysis model using the use record and the location information; and
a personalized search engine that applies the user preference analysis model to the local search results and deduces personalized final search results.

14. The mobile terminal of claim 13, wherein the user preference analysis model generator analyzes at least one of a favorite district, a favorite establishment type, a favorite brand, and a favorite establishment site of the user on the basis of at least one of the location information and the use record to generate the preference analysis model.

15. The mobile terminal of claim 13, wherein the personalized search engine preferentially extracts search results, which are included in a district, an establishment type, a brand, or an establishment site which the user prefers, from the local search results using the user preference analysis model.

16. The mobile terminal of claim 13, wherein the personalized search engine extracts search results, which are included in a district, an establishment type, a brand, or an establishment site which the user prefers, from the primary local search results using the user preference analysis model, and extracts the personalized final local search results from the extracted search results in consideration of age or a gender of the user.
